(19) United States
(12) Patent Application Publication
(10) Pub. No.: US 2007/0115355 A1
(43) Pub. Date: May 24, 2007

(54) Methods and apparatus for operating a pan tilt zoom camera

(76) Inventor: Kenneth McCormack, Albany, OR (US)

Correspondence Address: PATRICK W. RASCHE (22697);ARMSTRONG TEASDALE LLP, ONE METROPOLITAN SQUARE, SUITE 2600, ST. LOUIS, MO, 63102-2740, US

(21) Appl. No.: 11/282,347

(22) Filed: Nov. 18, 2005

(51) Int. Cl. H04N 7/18

(52) U.S. Cl. 348/143

(57) ABSTRACT

Methods and systems for a video camera assembly are provided. The video camera assembly includes a video camera, a pan mechanism configured to rotate the video camera about a pan axis, a tilt mechanism coupled to the pan mechanism wherein the tilt mechanism is configured to rotate the video camera about a tilt axis, and a controller communicatively coupled to the pan and tilt mechanisms. The controller is configured to receive a first image of a view acquired from a first address, receive a second image of the view acquired from a second address wherein the second address is different from the first address, compare the first image to the second image, and determine an offset between the first address and the second address using the comparison.

### BACKGROUND OF THE INVENTION

This invention relates generally to video surveillance systems and, more particularly, to calibrating presets for a pan/tilt/zoom capable camera assembly.

Surveillance video cameras associated with complex surveillance systems, such as those found in gaming establishments, schools, and shopping malls, are typically placed in transparent domes mounted in ceilings or other supports, such as on poles in a parking lot. In such systems, camera operators typically use a joystick type control to affect pan and tilt movements of various controllable cameras of the system. Zoom, focus, and iris functions of lenses coupled to these cameras are typically controlled by the joystick and/or a keypad having discrete keys marked with these functions. A video switching matrix selectively couples video outputs from the cameras to a plurality of monitors, with the switching matrix controlled, for example, through the use of the keypad.

At least some known surveillance applications include a plurality of cameras communicatively coupled to a lesser number of monitors or displays, which are all controlled manually and/or semi-automatically by the camera operator or controlled automatically by the surveillance system and monitored by the operator. In the areas under surveillance, camera operators need to be proficient with using the surveillance system and be thoroughly familiar with the layout of the areas being observed. To be effective, an operator must, within a short period of time, be able to switch one or more cameras to a particular view, such as a particular slot machine or gaming table. This may be accomplished using “presets” or addresses that direct a camera to a predetermined view by issuing a simple command rather than by selecting a particular camera from the plurality of cameras, recognizing the direction the camera is pointed and issuing pan, tilt, and zoom commands to point the camera to the desired view.

At least some known camera assemblies equipped with “preset” controls use, for example, servo mechanisms to position the camera to internally stored pan, tilt, zoom, focus, and iris positions. With this data, a plurality of “preset” views for each camera may be stored in the camera and used to direct the respective camera to a one, or a sequence, of these preset views responsive to operating a key on the keypad or from logic in a system control that automatically determines a desired view.

A camera that has greater than ninety degrees of travel in the tilt axis can address a preset from two perspectives. However, for the two perspectives to appear identical to the operator a calibration is used to remove positioning errors caused by mechanical and parallax distortions.

### BRIEF DESCRIPTION OF THE INVENTION

In one embodiment, a video camera assembly includes a video camera, a pan mechanism configured to rotate the video camera about a pan axis, a tilt mechanism coupled to the pan mechanism wherein the tilt mechanism is configured to rotate the video camera about a tilt axis, and a controller communicatively coupled to the pan and tilt mechanisms. The controller is configured to receive a first image of a view acquired from a first address, receive a second image of the view acquired from a second address wherein the second address is different from the first address, compare the first image to the second image, and determine an offset between the first address and the second address using the comparison.

In another embodiment, a method of calibrating a video camera assembly is provided. The video camera assembly includes a video camera and at least one of a pan mechanism, a tilt mechanism, and a zoom for defining a field of view of the camera, the pan mechanism configured to rotate the video camera about a pan axis, the tilt mechanism configured to rotate the video camera about a tilt axis. The method includes acquiring a first image of a view using a first camera assembly positional address, acquiring a second image of the view using a second camera assembly positional address, the second camera assembly positional address being a conjugate address with respect to the first camera assembly positional address, comparing the first and second images to determine an offset between the first and second images, and applying the offset to each camera assembly positional address and conjugate address.

In yet another embodiment, a method of operating a video camera assembly is provided. The video camera assembly includes a video camera and at least one of a pan mechanism, a tilt mechanism, and a zoom for defining a field of view of the video camera. The method includes receiving a preset command, determining an address from a plurality of addresses associated with the preset command, transmitting movement commands to the at least one of a pan mechanism, a tilt mechanism, and a zoom, and repositioning the camera assembly in response to the movement commands to a position associated with the address.

### BRIEF DESCRIPTION OF THE DRAWINGS

FIG. 1 is a schematic view of an exemplary video surveillance system in accordance with an embodiment of the present invention;

FIG. 2 is a schematic diagram of an exemplary embodiment of the pan, tilt, and zoom (PTZ) assembly shown in FIG. 1; and

FIG. 3 is a flowchart of an exemplary method of operating a video camera assembly.

### DETAILED DESCRIPTION OF THE INVENTION

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

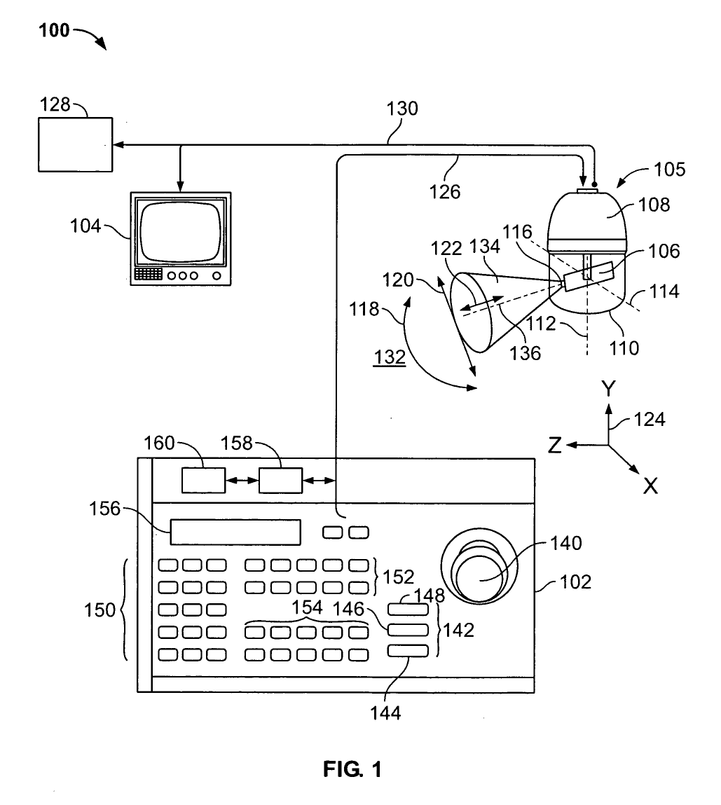

FIG. 1 is a schematic view of an exemplary video surveillance system 100 in accordance with an embodiment of the present invention. Video surveillance system 100 includes a control panel 102, a display monitor 104, and a pan, tilt, and zoom (PTZ) assembly 105. Typically, a camera 106 is housed in an enclosure 108 having a dome 110 for protecting camera 106 from the environment where camera 106 is located. In one embodiment, dome 110 is tinted to allow camera 106 to acquire images of the environment outside of enclosure 108 and simultaneously prevent individuals in the environment being observed by camera 106 from determining the orientation of camera 106. In various alternative embodiments, dome 110 is not tinted. In the exemplary embodiment, camera 106 includes capabilities to pan about a vertical axis 112, tilt about a horizontal axis 114, and control a lens assembly 116 to cause camera 106 to zoom. For example, PTZ assembly 105 includes a pan motor and encoder (not shown) and tilt motor and encoder (not shown). The encoders determine an angular position of the pan and tilt motor and generate position signals that are used with a zoom setting to determine an area in the field of view. Panning movement of camera 106 is represented by an arrow 118, tilting movement of camera 106 is represented by arrow 120 and the changing of the focal length of lens assembly 116 of camera 106, i.e., zooming, is represented by arrow 122. As shown with reference to a coordinate system 124, panning motion may track movement along the x-axis, titling motion may track movement along the y-axis and focal length adjustment may be used to track movement along the z-axis. Signals representing commands to control such capabilities are transmitted from control panel 102 through a control data line 126. Image data signals are transmitted from camera 106 to display monitor 104 and a storage device 128 through a video data line 130.

Lens assembly 116 views an area of a location 132, which may be remote from control panel 102 and is in a field of view 134 and along a viewing axis 136 of lens assembly 116. Images of location 132 are converted by camera 106 into an electrical video signal, which is transmitted to display monitor 104.

In the exemplary embodiment, control panel 102 includes an X-Y control joystick 140 that is used to generate pan and tilt commands. A plurality of rocker-type switches 142 are used to control a zoom 144, a focus 146, and an iris 148 of lens assembly 116. In an alternative embodiment, joystick 140 includes a twist actuation that is used to control the zoom of camera 106. Joystick 140 may also incorporate triggers and/or buttons to facilitate operating various controls associated with system 100. Control panel 102 also includes a numeric keypad 150 for entering numbers and values. In an alternative embodiment, control panel 102 may include an alpha or alphanumeric keypad (not shown) for entering text as well as numbers. Control panel 102 further includes a plurality of preset switches 152 that may be programmed to execute macros that automatically control the actions of camera 106 and/or lens assembly 116. A plurality of buttons 154 may be used, for example, for predetermined control functions and/or user-defined functions, for example, a camera selection in a multi-camera video surveillance system. A display 156 may be used to display a status of video surveillance system 100 or may be used to display parameters associated with a selected camera.

A processor 158 receives programmed instructions, from software, firmware, and data from memory 160 and performs various operations using the data and instructions. Processor 158 may include an arithmetic logic unit (ALU) that performs arithmetic and logical operations and a control unit that extracts instructions from memory 160 and decodes and executes them, calling on the ALU when necessary. Memory 160 generally includes a random-access memory (RAM) and a read-only memory (ROM), however, there may be other types of memory such as programmable read-only memory (PROM), erasable programmable read-only memory (EPROM) and electrically erasable programmable read-only memory (EEPROM). In addition, memory 160 may include an operating system, which executes on processor 158. The operating system performs basic tasks that include recognizing input, sending output to output devices, keeping track of files and directories and controlling various peripheral devices.

The term processor, as used herein, refers to central processing units, microprocessors, microcontrollers, reduced instruction set circuits (RISC), application specific integrated circuits (ASIC), logic circuits, and any other circuit or processor capable of executing the functions described herein. Memory 160 may include storage locations for the preset macro instructions that may be accessible using one of the plurality of preset switches 142.

As used herein, the terms “software” and “firmware” are interchangeable, and include any computer program stored in memory for execution by processor 158, including RAM memory, ROM memory, EPROM memory, EEPROM memory, and non-volatile RAM (NVRAM) memory. The above memory types are exemplary only, and are thus not limiting as to the types of memory usable for storage of a computer program.

In various embodiments, processor 158 and memory 160 are located external to camera 106 such as in control panel 102 or in a PC or other standalone or mainframe computer system capable of performing the functions described herein.

In the exemplary embodiment, video surveillance system 100 is a single camera application, however, various embodiments of the present invention may be used within a larger surveillance system having additional cameras which may be either stationary or moveable cameras or some combination thereof to provide coverage of a larger or more complex surveillance area. In an alternative embodiment, one or more video recorders (not shown) are connected to control panel 102 to provide for recording of video images captured by camera 106 and other cameras in system 100.

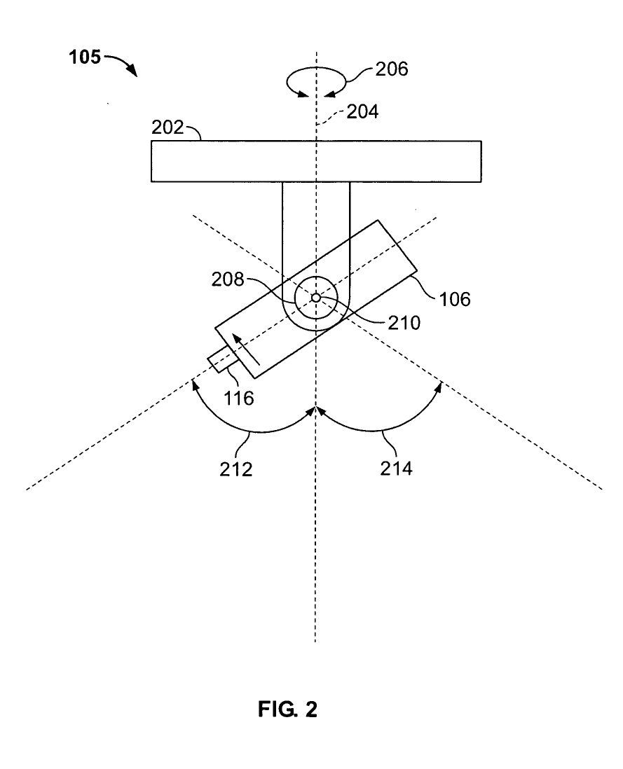

FIG. 2 is a schematic diagram of an exemplary embodiment of pan, tilt, and zoom (PTZ) assembly 105 (shown in FIG. 1). Video camera assembly 105 includes a camera 106, a pan mechanism 202 that is configured to rotate the video camera about a pan axis 204 in a clockwise and a counter clockwise pan direction 206. In the exemplary embodiment, pan mechanism 202 is configured to pan continuously about pan axis 204. In an alternative embodiment, pan mechanism 202 is configured to pan less than a full rotation about pan axis 204. Video camera assembly 105 also includes a tilt mechanism 208 coupled to the pan mechanism and configured to rotate video camera 106 about a tilt axis 210 (illustrated normal to the figure). In the exemplary embodiment, tilt mechanism 208 is configured to rotate camera 106 about tilt axis 210 greater than ninety degrees through an angle 212 and an angle 214 with respect to pan axis 204. A controller, such as control panel 102, is communicatively coupled to pan mechanism 202 and tilt mechanism 208. Controller 102 is configured to receive a first image of a view acquired from a first address wherein the address indicates a pan rotation angle with respect to an index, such as an initial starting or “parked” position. The address also indicates a tilt angle with respect to pan axis 204, and a view setting of lens assembly 116. In the exemplary embodiment, when camera 106 is rotated about tilt axis 210 through zero degrees with respect to pan axis 204, for example camera 106 is oriented pointing vertically downward, the video image is electronically flipped, such that the image, as perceived by the user is oriented right side up. Because pan mechanism 202 is capable of rotation greater than 360 degrees, and tilt mechanism 208 is capable of rotation greater than ninety degrees in each tilt direction from vertical, each view of camera 106 is addressable using two addresses. The second or conjugate address is offset one hundred eighty degrees of pan rotation with respect to the first address. The second address includes a tilt angle portion that is substantially equal to the tilt angle portion of the first address, but is rotated to the opposite side pan axis 204. The video image is flipped at the second address as compared to the video image at the first address to compensate for camera 106 being upside down as compared to its orientation at the first address. Additionally, the second address includes a zoom setting portion that is substantially equal to the zoom setting at the first address.

Each of the first address and the second address are used to point camera 106 at a view that is associated with a preset. A preset records the address of a view such that camera 106 may be automatically pointed in the direction of the view at a later time with little or no additional user actions. In the exemplary embodiment, two addressees are stored. A first address of the view is stored when the preset is commanded for that view. A second address is computed and stored. The second address includes conjugate corrections for the first address and corrections for mechanical inaccuracies between the first address and the second address, for example, due to camera parallax, lens variation from direct video to flip video, and tolerances of pan mechanism 202 and tilt mechanism 208.

To calibrate the first and second addresses such that the view imaged from either the first or second address is perceived to be the same by the user, an image acquired at the first address is compared to an image acquired at the second, conjugate address. In the exemplary embodiment, a pixel by pixel correlation is performed to determine a pan and tilt offset between the first and second images. In various other embodiments, other image difference algorithms are used to determine the offset, for example, locating a subimage in the first image that substantially matches a subimage in the second image is used. Controller 102 registers the images using determined landmarks in each image and determines correction factors that can be applied to the second address such that a view imaged using either address is perceived by the user as the same view. Once correction factors are determined, the first and second images may be discarded and the corrections are stored in memory associated with the preset addresses.

During operation, when the preset is selected, controller 102 determines the shortest path from the current address to the selected preset address. In one embodiment, the shortest path may be determined using a combination of angular distances camera 106 would need to be rotated to reach either preset address. In other embodiments, the shortest path may be determined using a time it would take for camera 106 to reach either preset address, for example, if pan mechanism 202 is capable of faster rotation than tilt mechanism 208.

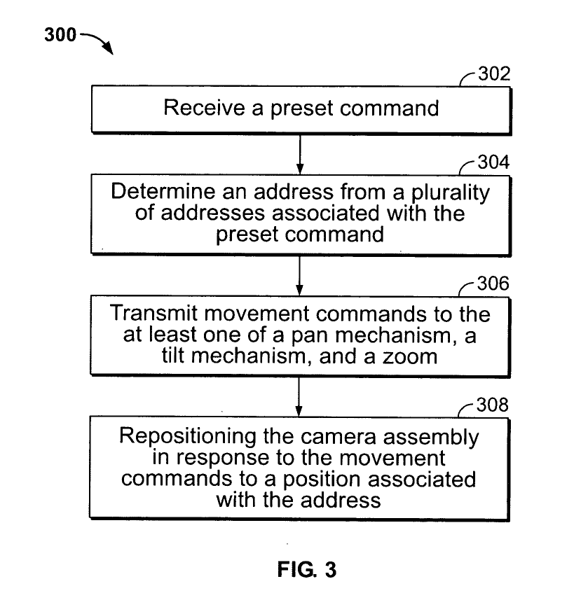

FIG. 3 is a flowchart of an exemplary method 300 of operating a video camera assembly that includes a video camera and at least one of a pan mechanism, a tilt mechanism, and a zoom for defining a field of view of the camera. Method 300 includes receiving 302 a preset command from a user operating a control console controlling the video camera assembly. The preset command may also be generated automatically by the controller in response to inputs received that indicate a particular preset view should be displayed. Such may be the case when an alarm indicates an intrusion into the area under surveillance that is served by the video camera assembly. The controller determines 304 an address from a plurality of addresses associated with the preset command. The camera assembly, during normal operation of automatic or manual panning, is typically positioned at a random address when the preset command is issued. The position of the camera assembly is known from encoders supplying position information to the controller or, in an open loop control configuration from the position commands transmitted to the camera assembly. In the exemplary embodiment, each preset has two addresses associated with it, a first address and a conjugate address. At the conjugate address, the pan mechanism 202 is rotated 180° from the pan mechanism position in the first address position, the tilt mechanism 208 is rotated through an angle 214 that is equal in magnitude to angle 212 at the first address, the zoom settings at both addresses are substantially equal, and the video image is flipped with respect to the video image at the first address position. Movement commands are transmitted 306 to at least one of pan mechanism 202, tilt mechanism 208, and the zoom. Camera 106 is repositioned 308 to orient camera 106 to the view associated with the preset addresses. To the user, the video image displayed will appear substantially the same regardless of the address used to direct camera 106 repositioning.

In the exemplary embodiment, a plurality of preset commands are stored in memory, such as memory 160. Each preset may be selected manually by the user or be selected automatically by controller 102 in response to execution of programmed instructions in software. Each of the plurality of preset commands are associated with a plurality of addresses wherein each address position orients camera 106 to substantially the same view. During operation, when a preset is selected, one address of the plurality of addresses is determined to be closest to the current position. Being closest relates to the shortest angular distance between the current position and the preset address position or the shortest transit time from the current position to the preset address position.

Exemplary embodiments of video surveillance systems and apparatus are described above in detail. The video surveillance system components illustrated are not limited to the specific embodiments described herein, but rather, components of each system may be utilized independently and separately from other components described herein. For example, the video surveillance system components described above may also be used in combination with different video surveillance system components.

A technical effect of the various embodiments of the systems and methods described herein include facilitating operation of the video surveillance system by using images of a preset view to calibrate a preset command.

While the invention has been described in terms of various specific embodiments, those skilled in the art will recognize that the invention can be practiced with modification within the spirit and scope of the claims.

What is claimed is:

1. A video camera assembly comprising:
a video camera;
a pan mechanism configured to rotate the video camera about a pan axis;
a tilt mechanism coupled to said pan mechanism, said tilt mechanism configured to rotate the video camera about a tilt axis; and
a controller communicatively coupled to said pan and tilt mechanisms, said controller configured to:
receive a first image of a view acquired from a first address;
receive a second image of the view acquired from a second address wherein the second address is different from the first address;
compare the first image to the second image; and
determine an offset between the first address and the second address using the comparison.

2. A system in accordance with claim 1 wherein said tilt mechanism is configured to rotate the video camera greater than 180 degrees about the tilt axis.

3. A system in accordance with claim 1 wherein said first address includes an angular position of the pan mechanism, an angular position of the tilt mechanism, and a zoom setting.

4. A system in accordance with claim 1 wherein said second address includes an angular position of the pan mechanism displaced by one-half of a rotation of the pan mechanism.

5. A system in accordance with claim 1 wherein said second address includes an angular position of the tilt mechanism that is equal to the magnitude of the angular position of the tilt mechanism at the first address wherein the tilt mechanism is rotated through the pan axis.

6. A method of calibrating a video camera assembly that includes a video camera and at least one of a pan mechanism, a tilt mechanism, and a zoom for defining a field of view of the camera, the pan mechanism configured to rotate the video camera about a pan axis, the tilt mechanism configured to rotate the video camera about a tilt axis, said method comprising:
acquiring a first image of a view using a first camera assembly positional address;
acquiring a second image of the view using a second camera assembly positional address, the second camera assembly positional address being a conjugate address with respect to the first camera assembly positional address;
comparing the first and second images to determine an offset between the first and second images; and
applying the offset to each camera assembly positional address and conjugate address.

7. A method in accordance with claim 6 wherein acquiring a first image of a view using a first camera assembly positional address comprises acquiring a first image of a view wherein the camera assembly positional address includes a pan angle component, a tilt angle component, and a zoom component.

8. A method in accordance with claim 7 wherein acquiring a second image of the view comprises determining a conjugate address with respect to the first camera assembly positional address.

9. A method in accordance with claim 8 wherein determining a conjugate address comprises determining a pan angle diametrically opposed to the pan angle component.

10. A method in accordance with claim 8 wherein determining a conjugate address comprises determining a tilt angle that is equal in magnitude to the tilt angle component and opposite to the tilt angle component with respect to the pan axis.

11. A method in accordance with claim 8 wherein determining a conjugate address comprises determining a zoom setting equal to the zoom component.

12. A method in accordance with claim 6 wherein comparing the first and second images to determine an offset between the first and second images comprises performing a pixel by pixel difference to determine an offset between the first and second images.

13. A method in accordance with claim 6 wherein comparing the first and second images to determine an offset between the first and second images comprises locating a subimage in the first image that substantially matches a subimage in the second image.

14. A method in accordance with claim 13 wherein locating a subimage in the first image that substantially matches a subimage in the second image further comprises determining an angular offset for at least one of the pan angle component, the tilt angle component, and the zoom component.

15. A method in accordance with claim 14 wherein applying the offset to each camera assembly positional address and conjugate address comprises applying the angular offset to each positional address and conjugate address.

16. A method of operating a video camera assembly that includes a video camera and at least one of a pan mechanism, a tilt mechanism, and a zoom for defining a field of view of the camera, said method comprising:
receiving a preset command;
determining an address from a plurality of addresses associated with the preset command;
transmitting movement commands to the at least one of a pan mechanism, a tilt mechanism, and a zoom; and
repositioning the camera assembly in response to the movement commands to a position associated with the address.

17. A method in accordance with claim 16 wherein receiving a preset command comprises receiving a preset command from a plurality of predetermined preset commands.

18. A method in accordance with claim 16 wherein said preset command is associated with a plurality of addresses.

19. A method in accordance with claim 16 wherein said determining an address associated with the preset command comprises determining an address from the plurality of addresses that is the shortest angular distance from the current address of the camera assembly.

20. A method in accordance with claim 16 wherein said determining an address associated with the preset command comprises determining an address from the plurality of addresses that is the shortest transit time from the current address of the camera assembly.
